(19) United States
(12) Patent Application Publication
(10) Pub. No.: US 2022/0324046 A1
(43) Pub. Date: Oct. 13, 2022

(54) Method for Manufacturing Core Plug of Gas Turbine Vane Using Brazing

(71) Applicants: Hyun Ki KANG, Busan (KR); Seok Yeong KANG, Busan (KR); Sang Woo JO, Busan (KR); Dong Kwan KIM, Seoul (KR); Young Ill AHN, Boryeong-si (KR); Yun Jin KIM, Boryeong-si (KR); Ha Yun SUNG, Boryeong-si (KR)

(72) Inventors: Hyun Ki KANG, Busan (KR); Seok Yeong KANG, Busan (KR); Sang Woo JO, Busan (KR); Dong Kwan KIM, Seoul (KR); Young Ill AHN, Boryeong-si (KR); Yun Jin KIM, Boryeong-si (KR); Ha Yun SUNG, Boryeong-si (KR)

(21) Appl. No.: 17/672,006

(22) Filed: Feb. 15, 2022

(30) Foreign Application Priority Data
Apr. 12, 2021 (KR) 10-2021-0047149

(51) Int. Cl. B23K 1/00; B23K 3/08; B24C 11/00

(52) U.S. Cl. CPC B23K 1/0018; B23K 3/085; B24C 11/00; B23K 2101/001

(57) ABSTRACT

The present invention relates to a method for manufacturing a core plug of a gas turbine vane, and more particularly to plan and design a core plug formation using brazing comprising: a first step of designing and planning a formation of a core plug; a second step of cutting a Hastelloy X plate according to the design of the core plug; a third step of fabricating a preform of the core plug; a fourth step of spot-welding a trailing edge; a fifth step of pasting a brazing filler; a sixth step of performing brazing heat treatment; a seventh step of performing grinding a brazed portion; an eighth step of performing a grit blasting.

According to the method for manufacturing a core plug of a gas turbine vane using brazing of the present invention above-mentioned, there is a significant effect of reducing manufacturing cost by in which the process is simple, and there is no deformation, shrinkages, cracks, and the like, in contrast with a conventional welding method.

### BACKGROUND OF THE INVENTION

### Field of the Invention

The present invention relates to a method for manufacturing a core plug of a gas turbine vane using brazing.

### Background of the Related Art

As gas turbine vanes are employed in a high temperature and a high pressure, and continuously loaded, a control of the base material is required through a cooling channel located in the vanes.

In particular, in order to cool down uniformly the entire regions of the airfoil of the vane through the cooling channel, a core plug is inserted inside of the airfoil of the vane.

Since the core plug is placed directly adjacent to the high pressurized air injected for cooling, a super heat-resisting alloy having a relatively low temperature compared to the airfoil may be applied.

A typical process for manufacturing a core plug of a gas turbine vane comprising in the steps of cutting a Hastelloy X plate, a widely known material, as per design in a drawing, and performing a plastic working into a preform after heat treatment before welding, that is, after making a molding by bending, perform welding by bonding the Tungsten Inert Gas (TIG) welding along the welding line which is in contact with a trailing edge portion, then perform the heat treatment.

The process may consume a long time since the process includes pre-and post-heat treatment processes, and there are some drawbacks in which deformation, shrinkage, and cracks may be generated due to a high welding temperature.

### PRIOR ART DOCUMENTS

### Non-Patent Document

OLA Oyedele T., OJO Olanrewaju A., WANJARA Priti, and CHATURVEDI Mahesh C., Advanced Materials Research Vol.278(2011) pp. 446-453

### Patent Documents

(Patent document 1) KR1020150037480(A) Welding material for welding of superalloys, filed in 8 Apr. 2015.

(Patent document 2) KR100663204(B1) Method for curing of weld defects in Ni-based superalloy components for gas turbine filed in 22 Dec. 2006.

(Patent document 3) EP2853339(A2) Welding material for welding of superalloys filed in 1 Apr. 2015.

### SUMMARY OF THE INVENTION

Therefore, the present invention has been made in view of the above problems, and it is an object of the present invention to provide a core plug of a gas turbine vane without any deformation, shrinkage, and cracks by performing a brazing process as an alternative of using a conventional Tungsten Inert Gas (TIG) welding.

To accomplish the above objects, according to one aspect of the present invention, there is provided a method for manufacturing a core plug of a gas turbine vane using brazing comprising: a first step of designing and planning a formation of a core plug; a second step of cutting a Hastelloy X plate according to the design of the core plug; a third step of fabricating a preform of the core plug; a fourth step of spot-welding a trailing edge; a fifth step of pasting a brazing filler; a sixth step of performing brazing heat treatment; a seventh step of performing grinding a brazed portion; an eighth step of performing a grit blasting.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 is a schematic diagram showing a core plug being inserted inside of a gas turbine vane.

FIG. 2 is a schematic diagram showing a core plug after molding and fixed on a copper jig before pasting the brazing filler.

FIG. 3 is a diagram illustrating the process of manufacturing a core plug of a gas turbine using brazing of the present invention.

FIG. 4 is a detailed diagram illustrating a process of brazing and heat treatment steps in the method for manufacturing a core plug of a gas turbine using brazing of the present invention.

### DETAILED DESCRIPTION OF THE PREFERRED EMBODIMENT

A method for manufacturing a core plug of a gas turbine vane using brazing of the present invention, comprising: a first step of designing and planning a formation of a core plug; a second step of cutting a Hastelloy X plate according to the design of the core plug; a third step of fabricating the core plug preform; a fourth step of spot-welding a trailing edge; a fifth step of pasting a brazing filler; a sixth step of performing brazing heat treatment; a seventh step of performing grinding a brazed portion; an eighth step of performing a grit blasting.

The method for manufacturing the core plug of the gas turbine vane using brazing of the present invention, wherein the sixth step includes: step 6-1, heating at a temperature of 500° C. to 540° C. for 10 minutes to 15 minutes, step 6-2, heating at a temperature of 900° C. to 950° C. for 8 minutes to 14 minutes, step 6-3, heating at a temperature of 1100° C. to 1130° C. for 2 minutes to 5 minutes, step 6-4, cooling at a temperature of up to 900° C., and step 6-5, cooling at a temperature of 100° C. or below.

In addition, in step 6-4 above-mentioned may comprise performing at a cooling rate of 11° C./min to 15° C./min.

Hereinafter, the present invention is described in detail with reference to the attached drawings of a method of manufacturing a core plug of a gas turbine vane using brazing of the present invention is as follows.

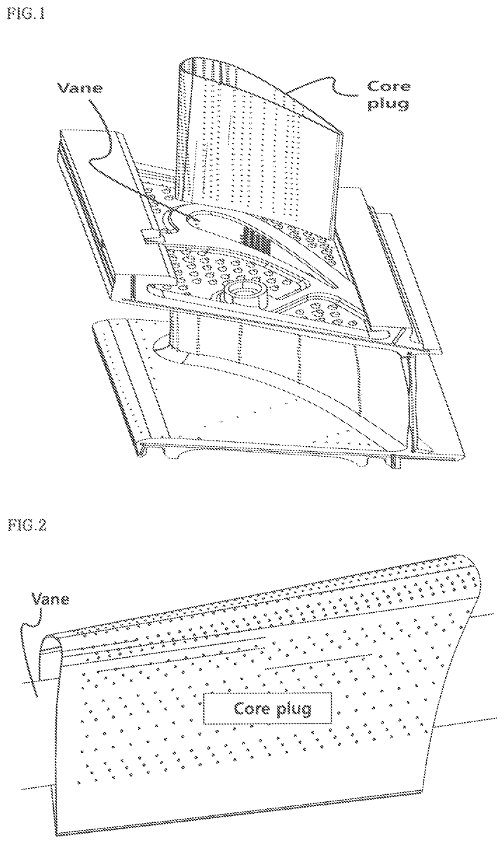

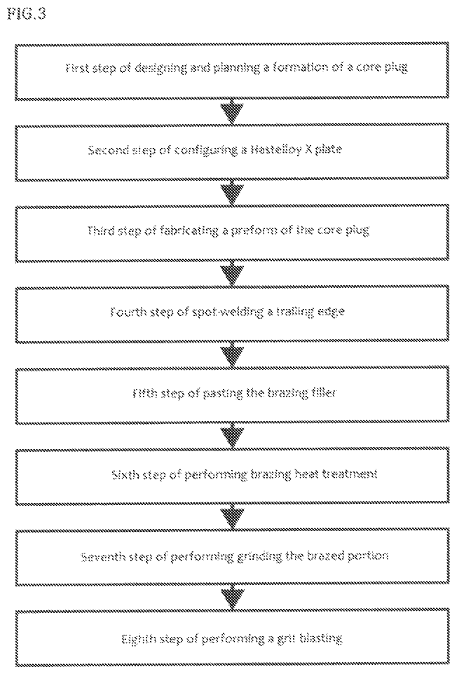

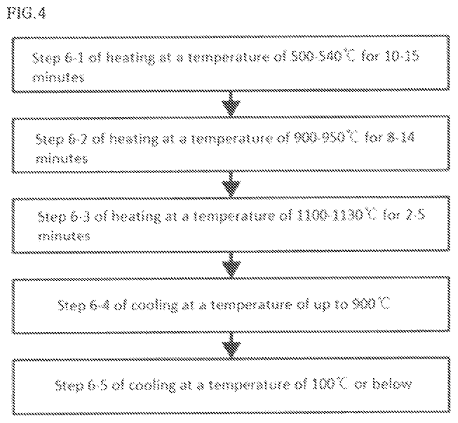

Referring now to the drawings, FIG. 1 is a schematic diagram showing a core plug being inserted inside of a gas turbine vane, FIG. 2 is a schematic diagram showing a core plug after molding and fixed on a copper jig before pasting the brazing filler, FIG. 3 is a diagram illustrating a process of manufacturing a core plug of a gas turbine using the brazing of the present invention, and FIG. 4 is a detailed diagram illustrating a process of brazing and heat treatment steps in the method for manufacturing a core plug of a gas turbine using brazing of the present invention.

As illustrated in FIGS. 1 to 4, the present invention relates to a method for manufacturing a core plug of a gas turbine vane using brazing.

More particularly, to the method comprising a first step of planning and designing a formation of core plug for the fabrication, and a second step of cutting a Hastelloy X plate as per design of a core plug.

The Hastelloy metal is a nickel-base alloy that has high-temperature strength, excellent oxidation resistance and workability.

Hastelloy X is a heat-resisting alloy having excellent oxidation resistance, and is suitable for fabricating a core plug of a gas turbine of the present invention.

A third step includes the process of fabricating a core plug preform using a cut Hastelloy X according to the design.

Preferably, the cut Hastelloy X is plastically processed with a mold to fabricate a core plug preform.

A fourth step includes a process of spot-welding a trailing edge.

In other words, the step includes the process of spot-welding on the trailing edge portion of the core plug preform.

A fifth step includes a process of pasting with a brazing filler.

AMS4778H may be used for the brazing paste.

The paste may be referred to as a solvent.

A sixth step is a brazing heat-treatment process.

The sixth step may break down into steps of: step 6-1, heating at a temperature of 500° C. to 540° C. for 10 minutes to 15 minutes, step 6-2, heating at a temperature of 900° C. to 950° C. for 8 minutes to 14 minutes, step 6-3, heating at a temperature of 1100° C. to 1130° C. for 2 minutes to 5 minutes, step 6-4, cooling at a temperature of up to 900° C., and step 6-5, cooling at a temperature of 100° C. or below.

More specifically, step 6-1 is a process of removing moisture or organic matters included in the preform, by heating at a temperature of 500° C. to 540° C. for 10 minutes to 15 minutes.

Further, step 6-2 is a process of maintaining the entire preform at a constant temperature by heating at a temperature of 900° C. to 950° C. for 8 minutes to 14 minutes.

In step 6-3, the reason for heating the preform at a high temperature of 1100° C. to 1130° C. for 2 minutes to 5 minutes is to bond the preform by melting the coated brazing paste.

In step 6-4, by cooling the preform that is bonded with the brazing filler, down to a temperature of 900° C. using furnace cooling process, the process is to evenly coagulate and maintain the preform at a constant temperature in general.

Further, in step 6-5, after cooling down to a temperature of 500° C. to 900° C. by argon gas fan, the preform is gradually cooled down to 100° C. in order to unload from a vacuum furnace.

At this point, in step 6-4 above-mentioned, the step may perform at a cooling rate of 11° C./min to 15° C./min.

After carrying out the sixth step, a seventh step is as follows, which a process of grinding to smooth out the surface area from brazing.

Finally, an eighth step is a process of grit blasting to complete the process.

The grit blasting is performed under the conditions of pressure at 3 kg/cm² to 5 kg/cm², and the size of an alumina particle of 30 mesh to 50 mesh.

According to the method for manufacturing the core plug of the gas turbine vane using brazing of the present invention as above mentioned, there is a significant effect of reducing manufacturing cost by performing cutting a Hastelloy X plate, forming a plastic working into a preform, that is, by bending the preform, then performing a spot-welding along the welding line, which is in contact with a trailing edge portion, then performing a pasting the brazing filler and a heat treatment, in which the process is simple, and there is no deformation, shrinkage, cracks, and the like, in contrast with a conventional welding method.

What is claimed is:

1. A method for manufacturing a core plug of a gas turbine vane using brazing, comprising:
a first step of designing and planning a formation of a core plug; a second step of cutting a Hastelloy X plate according to the design of the core plug; a third step of fabricating a preform of the core plug; a fourth step of spot-welding a trailing edge; a fifth step of pasting the brazing filler; a sixth step of performing brazing heat treatment; a seventh step of performing grinding a brazed portion; an eighth step of performing a grit blasting, and wherein the sixth step comprises in the steps of: step (6-1), heating at a temperature of 500° C. to 540° C. for 10 minutes to 15 minutes, step (6-2), heating at a temperature of 900° C. to 950° C. for 8 minutes to 14 minutes, step (6-3), heating at a temperature of 1100° C. to 1130° C. for 2 minutes to 5 minutes, step (6-4), cooling at a temperature of up to 900° C., and step (6-5), cooling at a temperature of 100° C. or below.

2. The method according to claim 1, wherein in said step (6-4), the step may perform at a cooling rate of 11° C./min to 15° C./min.

3. The method according to claim 1, wherein in said step (6-5), after cooling down to a temperature of from 900° C. to 500° C. by argon gas fan, the preform is gradually cooled down to 100° C. in order to unload from a vacuum furnace.

4. The method according to claim 1, wherein the grit blasting process of the eighth step is performed under the conditions of a pressure at 3 kg/cm² to 5 kg/cm², and a size of alumina particle of 30 mesh to 50 mesh.
